(19) United States
(12) Patent Application Publication
(10) Pub. No.: US 2010/0075741 A1
(43) Pub. Date: Mar. 25, 2010

(54) WAGERING GAME WITH SYMBOL ARRAY PROVIDING AWARDS BASED ON ARRAY PATHS

(75) Inventors: Dion K. Aoki, Henderson, NV (US); Allon G. Englman, Chicago, IL (US); Benjamin T. Gomez, Chicago, IL (US)

Correspondence Address: NIXON PEABODY LLP, 300 S. Riverside Plaza, 16th Floor, CHICAGO, IL, 60606, US

(73) Assignee: WMS Garming Inc., Waukegan, IL (US)

(21) Appl. No.: 12/442,765

(22) PCT Filed: Sep. 21, 2007
(86) PCT No.: PCT/US07/20493

§ 371 Date: Mar. 24, 2009

Related U.S. Application Data
(60) Provisional application No. 60/846,923, filed on Sep. 25, 2006.

(51) Int. Cl. A63F 9/24; A63F 13/00

(52) U.S. Cl. 463/20; 463/30

(57) ABSTRACT

A gaming system for conducting a wagering game includes a wager input device for receiving a wager, The gaming system further includes at least one display for displaying an array of symbols indicating a randomly selected outcome. The array of symbols include a plurality of rows and a plurality of columns. The symbols include directional indicators. The randomly selected outcome is indicated by at least one sequence of symbols formed based on directions associated with the directional indicators. In response to the sequence of symbols including a predetermined symbol, an award associated with the predetermined symbol is awarded.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a wagering game having a symbol array and providing awards based on one or more sequences of symbols within the array.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

### SUMMARY OF THE INVENTION

According to one aspect of the present invention, a gaming system for conducting a wagering game includes a wager input device for receiving a wager. The gaming system further includes at least one display for displaying an array of symbols indicating a randomly selected outcome. The array of symbols include a plurality of rows and a plurality of columns. The symbols include directional indicators. The randomly selected outcome is indicated by at least one sequence of symbols formed based on directions associated with the directional indicators. In response to the sequence of symbols including a predetermined symbol, an award associated with the predetermined symbol is awarded.

According to another aspect of the invention, a method of conducting a wagering game on a gaming system comprises displaying a plurality of symbols in an array indicating a randomly selected outcome of the wagering game. The array includes a plurality of rows and a plurality of columns. The plurality of symbols include directional indicators. The method further comprises forming a sequence of symbols based on a direction associated with the directional indicators. The method further comprises, in response to the sequence of symbols including a winning symbol, awarding an award associated with the winning symbol.

According to another aspect of the invention, a method of conducting a wagering game on a gaming system comprises displaying an array including a plurality of symbol locations. The method further comprises activating at least one starting position, the starting position being positioned adjacent to one of the symbol locations. The method further comprises displaying a plurality of symbols in the array indicating a randomly selected outcome of the wagering game. The plurality of symbols include directional indicators. The method further comprises forming a sequence including a plurality of symbols, wherein a first symbol is adjacent to the activated starting position, a second symbol being adjacent to the first symbol in a direction associated with a first directional indicator of the first symbol, and a third symbol being adjacent to the second symbol in a direction associated with a second direction indicator of the second symbol. The method further comprises, in response to the first symbol, the second symbol, or the third symbol being a winning symbol, awarding an award associated with the winning symbol.

According to yet another aspect of the invention, a computer readable storage medium is encoded with instructions for directing a gaming system to perform the above method.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machines of FIGS. 1a and 1b;

FIG. 3a is a display of a wagering game screen in an intermediate stage in with reels of the wagering game are spinning, according to one embodiment of the present invention;

FIG. 3b is a display of a wagering game screen subsequent to FIG. 3a;

FIG. 3c is a display of a wagering game screen subsequent to FIG. 3b;

FIG. 3d is a display of a wagering game screen subsequent to FIG. 3c;

FIG. 3e is a display of a wagering game screen subsequent to FIG. 3d;

FIG. 3f is a display of a wagering game screen subsequent to FIG. 3e;

FIG. 3g is a display of a wagering game screen subsequent to FIG. 3f;

FIG. 4a is a representative view of a display of a wagering game, according to one embodiment of the present invention, after a first wager amount has been placed;

FIG. 4b is a display of a wagering game screen of FIG. 4a after a second wager amount has been placed;

FIG. 4c is a display of a wagering game screen of FIG. 4a after a third wager amount has been placed;

FIG. 4d is a display of a wagering game screen of FIG. 4a after a fourth wager amount has been placed;

FIG. 4e is a display of a wagering game screen of FIG. 4a after a fifth wager amount has been placed;

FIG. 4f is a display of a wagering game screen of FIG. 4a after a sixth wager amount has been placed;

FIG. 5a is a representative view of a display of a wagering game, according to one embodiment of the present invention, after a first wager amount has been placed;

FIG. 5b is a display of a wagering game screen of FIG. 5a after a second wager amount has been placed;

FIG. 5c is a display of a wagering game screen of FIG. 5a after a third wager amount has been placed;

FIG. 5d is a display of a wagering game screen of FIG. 5a after a fourth wager amount has been placed;

FIG. 5e is a display of a wagering game screen of FIG. 5a after a fifth wager amount has been placed;

FIG. 5f is a display of a wagering game screen of FIG. 5a after a sixth wager amount has been placed;

FIG. 6a is a display of a wagering game screen according to another embodiment of the present invention;

FIG. 6b is a display of a wagering game screen in an intermediate stage in which symbols of the wagering game are being dropped into position; and

FIG. 6c is a display of a wagering game screen subsequent to FIG. 6b.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

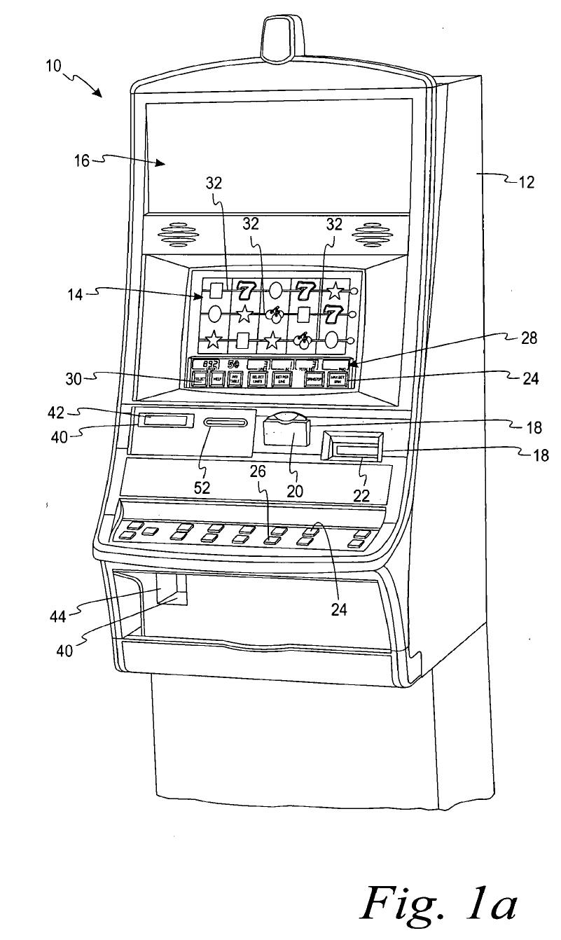

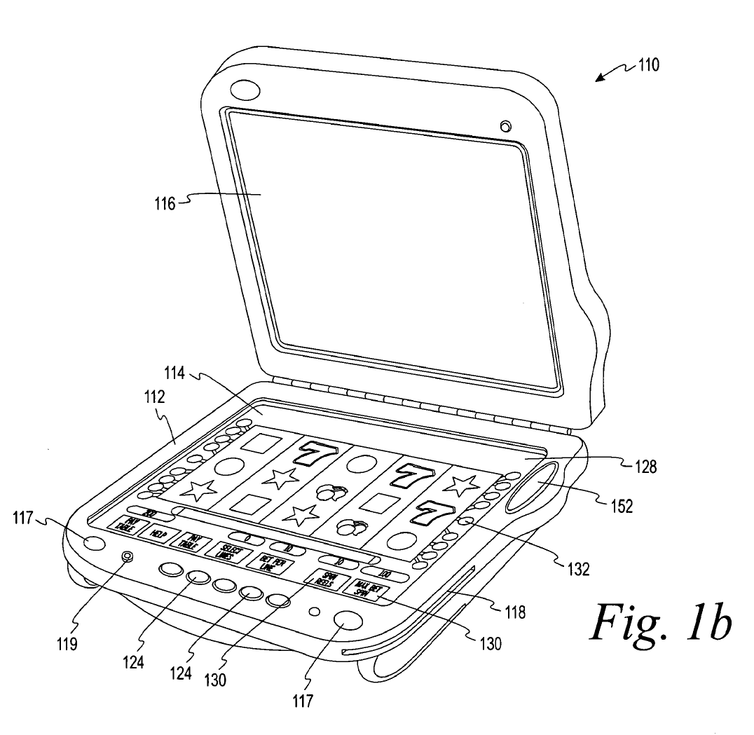

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

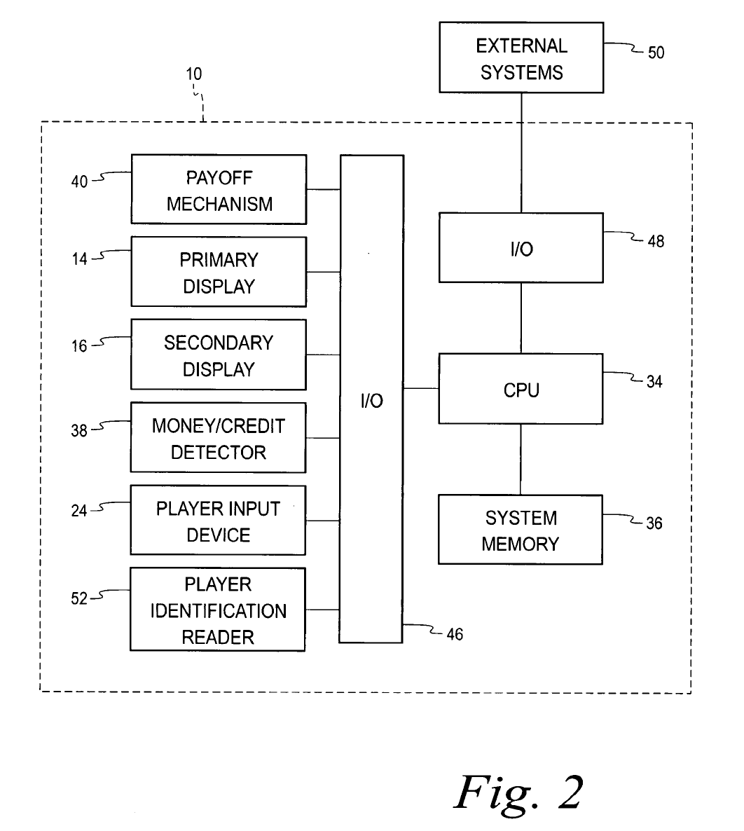

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10,110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

### UpWins Wagering Game

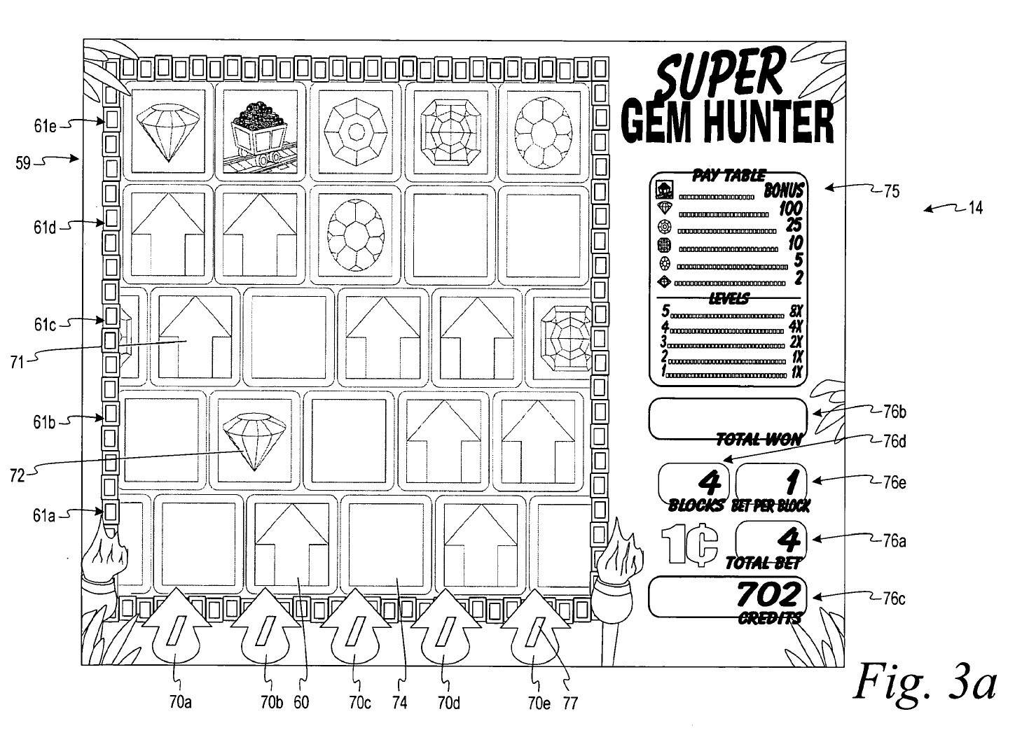

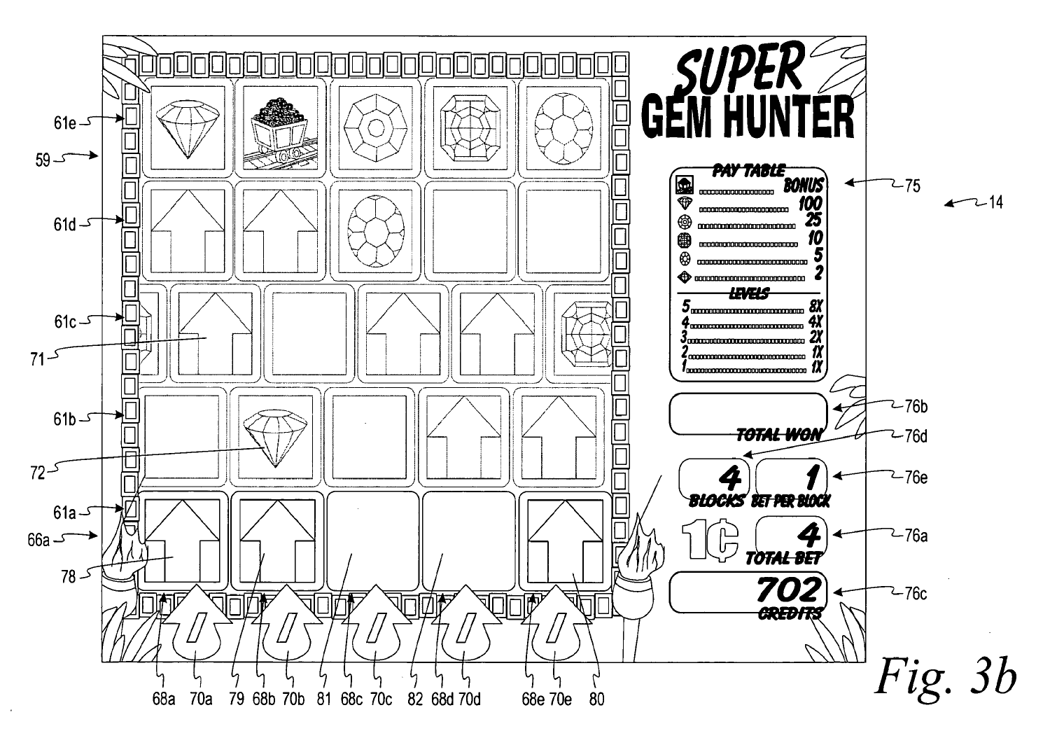

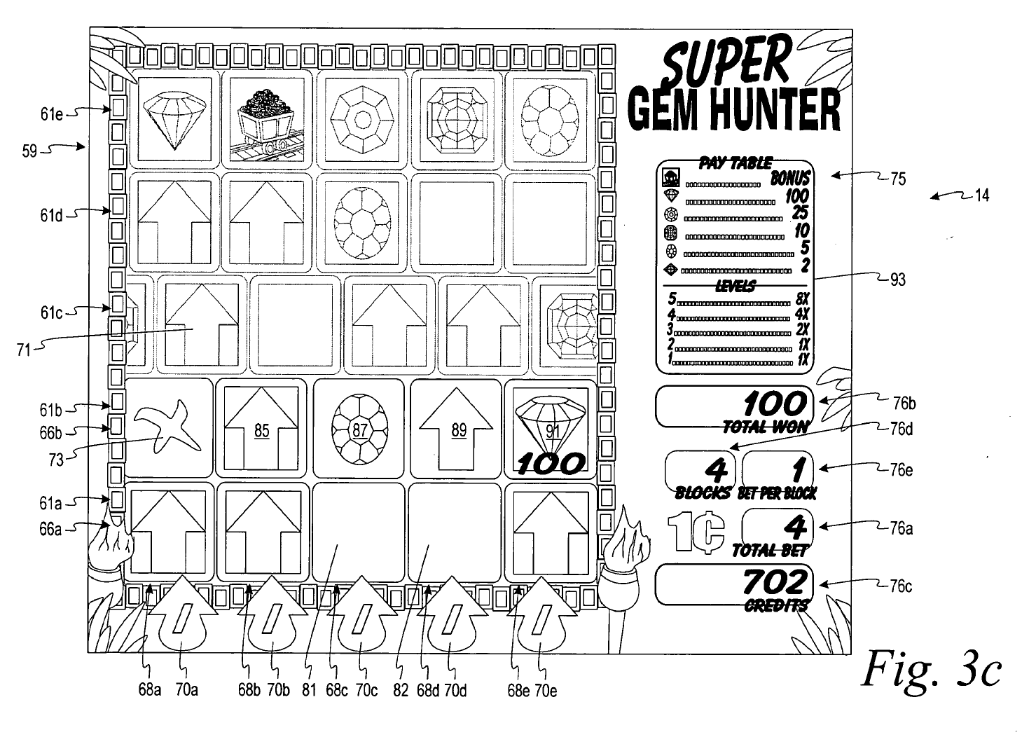

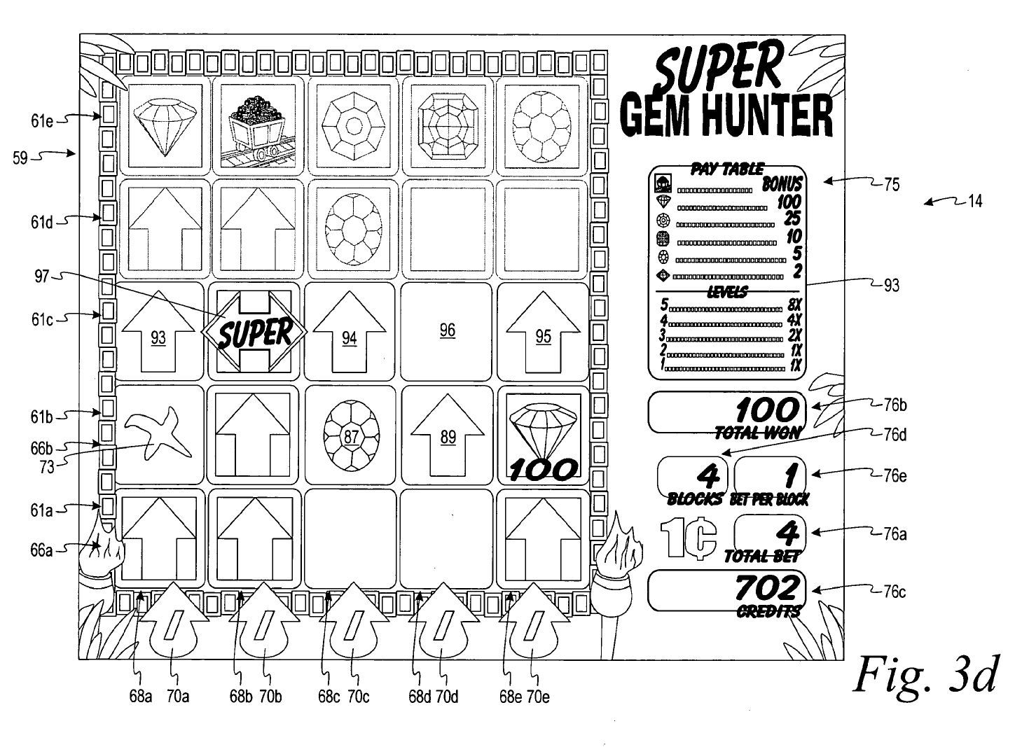

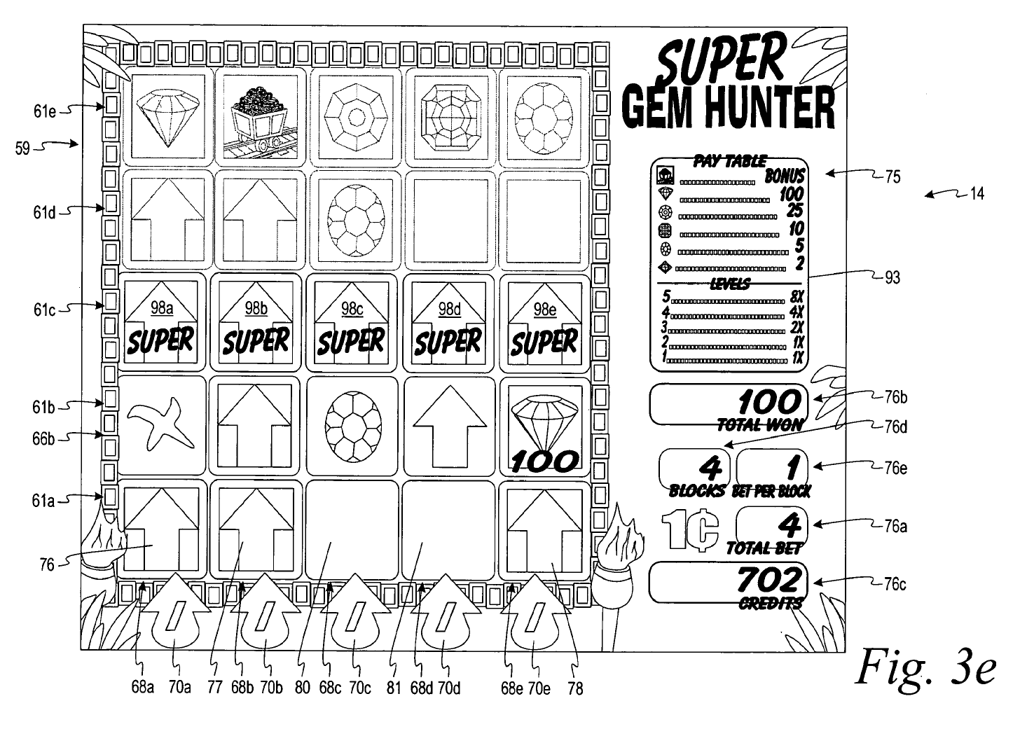

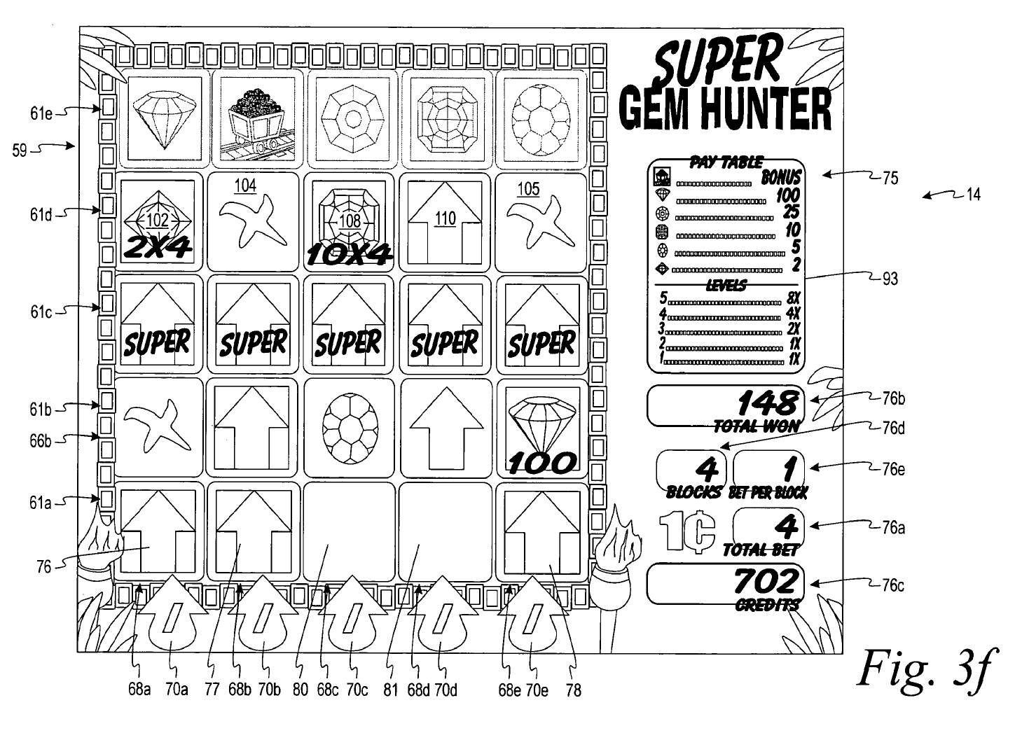

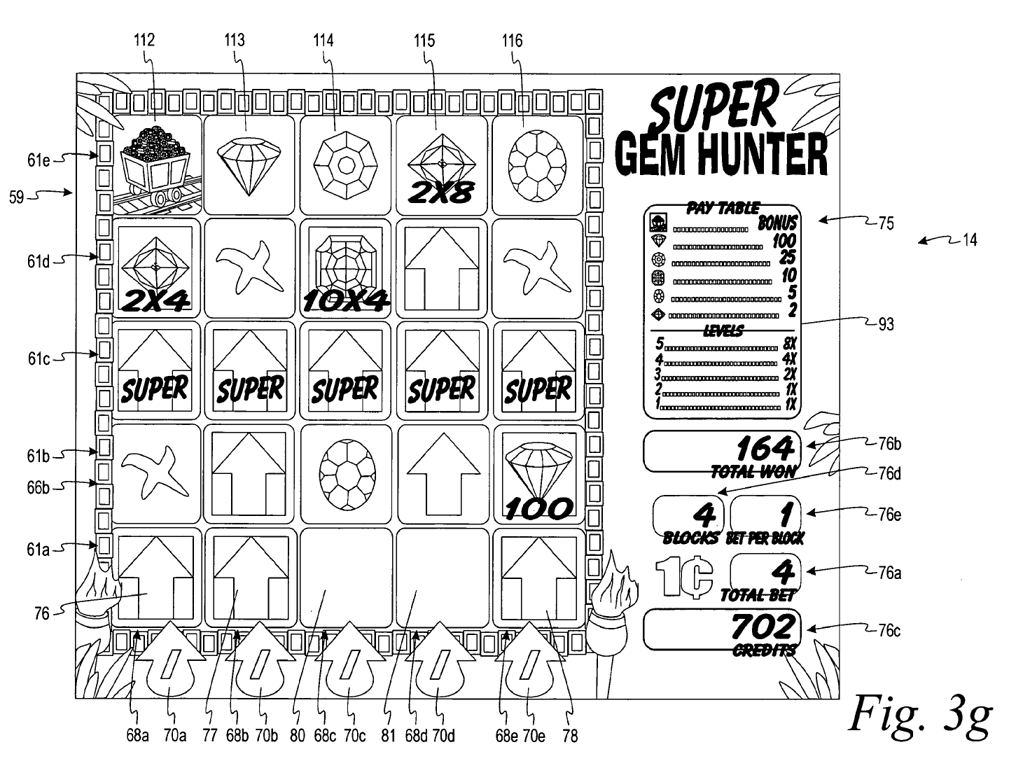

Turning now to FIG. 3a, the primary display 14 is shown displaying a wagering game according to one embodiment of the present invention. The wagering game of FIG. 3a includes an array 59 comprised of a plurality of symbols 60 positioned on five horizontal reels 61a-e. The reels 61a-e may be traditional mechanical reels, electromechanical reels, or computer-generated images of reels.

The array 59 in the illustrated example includes five rows 66a-e (see FIG. 3g) corresponding with each of the five reels 61a-e. The array 59 also includes five columns 68a-e (see FIG. 3b) corresponding with each of five starting position 70a-e positioned at the bottom of the array 59. The array 59 may include a different amount of reels 61a-e and corresponding rows 66a-e. Additionally, or alternatively, the array 59 may include a different amount of starting positions 70a-e and corresponding columns 68a-e. The starting positions 70a-e may also be located in other positions on the display 14 (e.g., near the top of the display 14, near a side of the display 14), have other shapes, combinations thereof, or the like.

Various types of symbols are shown in the embodiment of FIGS. 3a-g. One type of symbol includes a directional indicator symbol, or an arrow pointing in an up direction (“upward arrows” 71). Various types of gem symbols (e.g., gem symbol 72), “X” symbols (e.g., “X” symbol 73 of FIG. 3c), and blank symbols (e.g., blank symbol 74) are also included in the illustrated embodiment. Other types of symbols may also be used.

The display 14 further includes an outcome indicator 75. The outcome indicator 75 indicates whether the outcome of the wagering game has resulted in a payout, a progressive jackpot, a bonus game, or whether it resulted in no reward at all. The outcome indicator 75 may also provide the player with information such as the amount of the current wager (e.g., TOTAL BET indicator 76a), the amount awarded (e.g., TOTAL WON indicator 76b), the total number of credits remaining (e.g., CREDITS indicator 76c), and the like. In the illustrated example, the outcome indicator 75 further includes a BLOCKS indicator 76d that indicates that all five (5) blocks, or starting positions 70a-e, have been selected by the player. The outcome indicator 75 also includes a BET PER BLOCK indicator 76e that indicates that one (1) credit was wagered per block or starting position 70a-e. Furthermore, a “1” graphic 77 is displayed within each of the starting positions 70a-e so that the amount of credits wagered per starting position 70a-e is readily visible to the player. The TOTAL BET indicator 76a thus indicates that a total of five (5) credits have been wagered. The player may place a wager on less than all of the starting positions 70a-e. Furthermore, the player may wager more than one credit per starting position 70a-e (e.g., up to five credits).

Once the player has placed the wager and selected and/or activated one or more starting positions 70a-e, the player may press a button (e.g., button 26 of FIG. 1a) or otherwise cause the reels 61a-e to spin, as shown in FIG. 3b. The reels 61a-e may spin from left to right or right to left. Alternatively, the symbols may drop down from the top of the display 14, fade in, or otherwise be revealed on the display 14. Other suitable ways of revealing the symbols on the display 14 may also be used.

In the illustrated example, each of the reels 61a-e stops spinning, one at a time, beginning with the reel positioned adjacent to the starting positions 70a-e (i.e., a first reel 61a). A sequence of symbols, or “chain,” may be formed beginning at a starting position 70a-e. The sequences of the illustrated examples are evaluated from the bottom of the array 59 to the top of the array. The chain links upward arrows until another symbol 60 (i.e., a gem symbol 72, an “X” symbol 73, or a blank symbol 74) is encountered, at which point the chain ends. For example, an upward arrow 71 generated in the first row 66a allows the chain to continue to the second row 61b, thereby advancing the player to the next level or row 66a-e. An upward arrow 71 generated in the second row 66b allows the chain to continue to the third row 66c, and so on. If the chain is linked to a winning symbol (e.g., a gem symbol 72), the player is awarded the credit value associated with that winning symbol. The credit value may further be multiplied by the level or row 66a-e corresponding with the winning symbol. If the chain is linked to an “X” symbol 73 or a blank symbol 74, the corresponding column 68a-e is deactivated (i.e., the chain ends), and the player does not received a payout associated with that chain.

FIG. 3b shows the display 14 after the first reel 61a has stopped spinning. The resulting first row 66a includes upward arrows 78-80 positioned in the first, second, and fifth columns 68a,b,e. The first reel 61a further includes blank symbols 81, 82 positioned in the third and fourth columns 68c,d. The upward arrows 78-80 advance the player to the next level corresponding with a second row 66b (see FIG. 3c). The blank symbols 81, 82 deactivate the columns 68c,d associated therewith. To emphasize that the symbols 81, 82 and/or columns 68c,d have been deactivated, they may appear dimmer, shaded, without a border. or the like, as in FIGS. 3b-g.

FIG. 3c illustrates one example of the display 14 after the second reel 61b has stopped spinning, resulting in the second row 66b. The “X” symbol 73 is positioned in the first column 68a. The “X” symbol 73 denotes that the player may not advance to the third level corresponding with a third row 66c (see FIG. 3d) of the first column 68a. Thus, the first column 68a is deactivated. An upward arrow 85 is positioned in the second column 68b of the second row 66b, thus advancing the player to the third level of the second column 68b. An oval gem symbol 87 and an upward arrow 89 are positioned, respectively, in the third and fourth columns 68c,d of the second row 66b. These symbols are generally irrelevant for purposes of determining an award since the corresponding columns 68c,d have been deactivated because the blank symbols 80, 81 were generated in the first row 66a. However, allowing the player to view the symbols in deactivated columns may increase a player's level of anticipation and excitement.

A diamond symbol 91 is positioned in the fifth column 68e of the second row 66b. According to a pay table 93 shown on the outcome indicator 75, the diamond symbol 91 is a winning symbol. The pay table 93 indicates a credit amount award associated with each type of winning symbol. Furthermore, although not necessary, the pay table 93 indicates a multiplier associated with each level (i.e., row 66a-e) on which the winning symbol is generated. Other multipliers than those shown in the illustrated examples may be used. Thus, the diamond symbol 91 of FIG. 3c corresponds with an award of one hundred (100) credits. The multiplier associated with the second level is one (1). Thus, the player is awarded one hundred credits, as shown in the TOTAL WON indicator 76b.

In the illustrated example, the various winning symbols are associated with different credit amounts. However, the winning symbols may also be associated with other types of awards including monetary and non-monetary awards. The non-monetary awards may include free spins, multipliers, entry into a bonus game, entry into a progressive game, or the like.

Furthermore, in the illustrated embodiments, a winning symbol (e.g., the diamond symbol 91) ends the chain and prohibits the player from advancing to the next level. However, the winning symbol may also function like an upward arrow 71, thereby advancing the player to the next level.

FIG. 3d illustrates the display 14 after the third reel 61c has stopped spinning, resulting in the third row 66c, according to one embodiment. Upward arrows 93-95 are positioned in the first, third, and fifth columns 68a,c,e. A blank symbol 96 is positioned in the fourth column 68d. A super arrow symbol 97 is positioned in the second column 68b of the third row 66c. The super arrow symbol 97 acts as an expanding wild. Thus, generating the supper arrow symbol 97 in the third row 66c branches the sequence corresponding with the second starting position 70b into multiple sequences, thereby reactivating the entire third row 66c. In one example, if less than all of the starting positions 70a-e were activated, only the columns 68a-e corresponding with the initially activated starting positions 70a-e may be reactivated. As shown in FIG. 3e, super upwards arrows 98a-e replace each of the symbols 93-95 previously positioned in the third row 66c. It should be noted that the reactivation of the symbols in the row including a super arrow symbol 97 may be indicated in other ways including, but not limited to, relighting the deactivated symbols. This may be particularly desirable in gaming machines having electromechanical reels.

FIG. 3f illustrates the display 14 after the fourth reel 61d has stopped spinning, resulting in a fourth row 66d, according to one embodiment. A second gem symbol 102 is positioned in the first column 68a. According to the pay table 93, generating a second gem symbol in an activated column provides an award of two (2) credits. The multiplier associated with the fourth row 66d or level is four (4). Thus, the player is awarded eight credits (i.e., two credits times a multiplier of four). The second and fifth columns 68b,e include “X” symbols 104, 105, thereby deactivating the corresponding columns 68b,e. The third column 68c includes a third gem symbol 108 providing a payout of ten (10) credits. The payout is then multiplied by the corresponding multiplier of four, and a resulting award of forty (40) credits is awarded to the player. An upward arrow 110 is positioned in the fourth column 68d, thus advancing the player to the level corresponding with a fifth row 66e (see FIG. 3g).

Turning now to FIG. 3g, the display 14 is shown after the fifth reel 61e has stopped spinning, resulting in the fifth row 66e. In the embodiment of FIG. 3g, all symbols 112-116 of the fifth row 66e are winning symbols. However, in other embodiments, some or none of the symbols 60 of the fifth row 66e may be winning symbols. Because only the fourth column 68d remains activated, however, the player is only awarded the payout associated with a fourth gem symbol 115 positioned in the fourth column 68d. The payout for the fourth gem symbol 112 is two (2) credits multiplied by a multiplier of eight (8) associated with the fifth row 66e or level. Thus, the player is awarded a total of one hundred sixty-four (164) credit, as shown in the TOTAL WON indicator 76b of the outcome indicator 75.

The display 14 of FIG. 3g further includes a bonus symbol 112 positioned in the first column 68a of the fifth row 66e. The bonus symbol 112 may provide the player with any suitable awards including a bonus game, an additional multiplier, combinations thereof, or the like. In one example, the bonus symbol 112 provide an award regardless of whether the column 68a-e in which it is positioned is activated or deactivated.

The player of FIGS. 3a-g has wagered one credit per starting position 70a-e, as shown in the BET PER BLOCK indicator 76b. However, other wager amounts and wagering schemes may also be made, as described below.

Although in the example of FIGS. 3a-g, the sequences of symbols are evaluated from the bottom of the display 14 to the top of the display 14, in other embodiments, the sequences may be evaluated top to bottom, left to right, right to left, or the like.

Furthermore, in the example of FIGS. 3a-g, any upward arrow 71 advances the player to the next level or row 66a-e. However, in other examples, only certain upward arrows 71 allow the player to advance. In one non-limiting example, to advance a player to the next row 66a-e or level, the upward arrow may be required to have a color corresponding to a color of the corresponding starting position 70a-e.

### Wagering Scheme 1

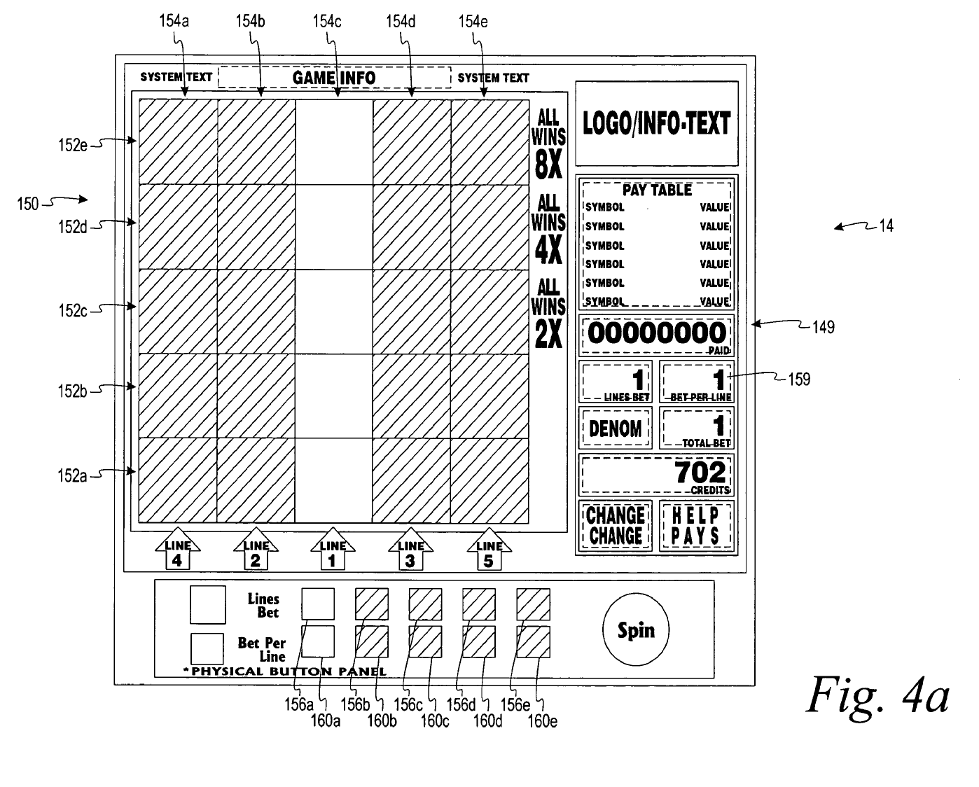

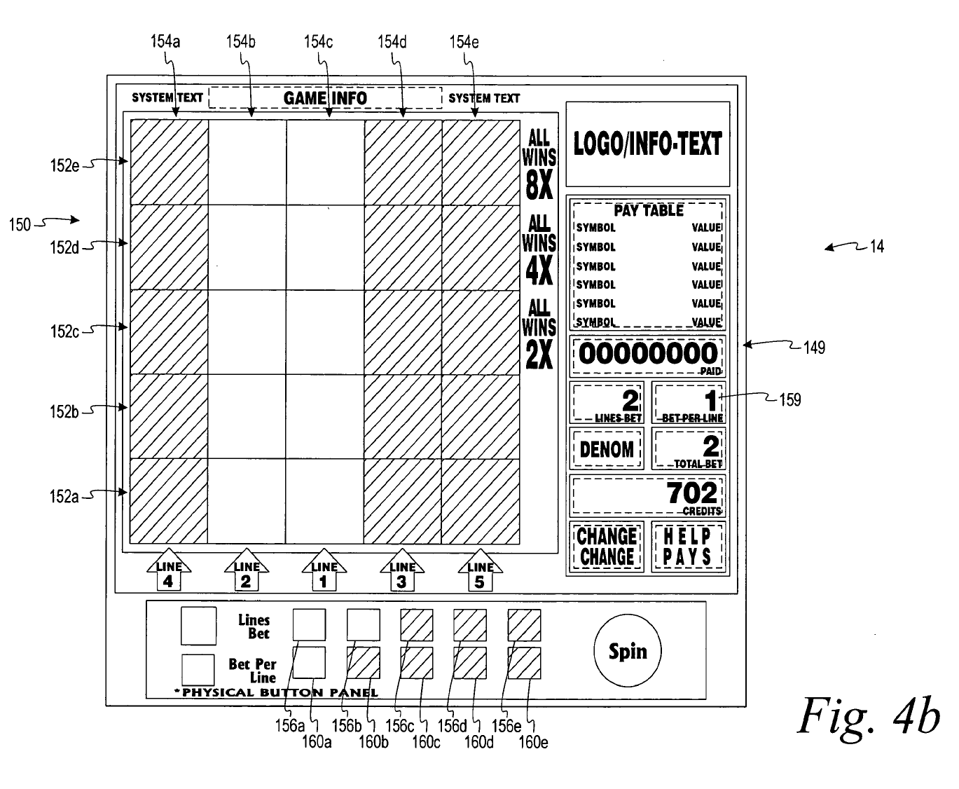

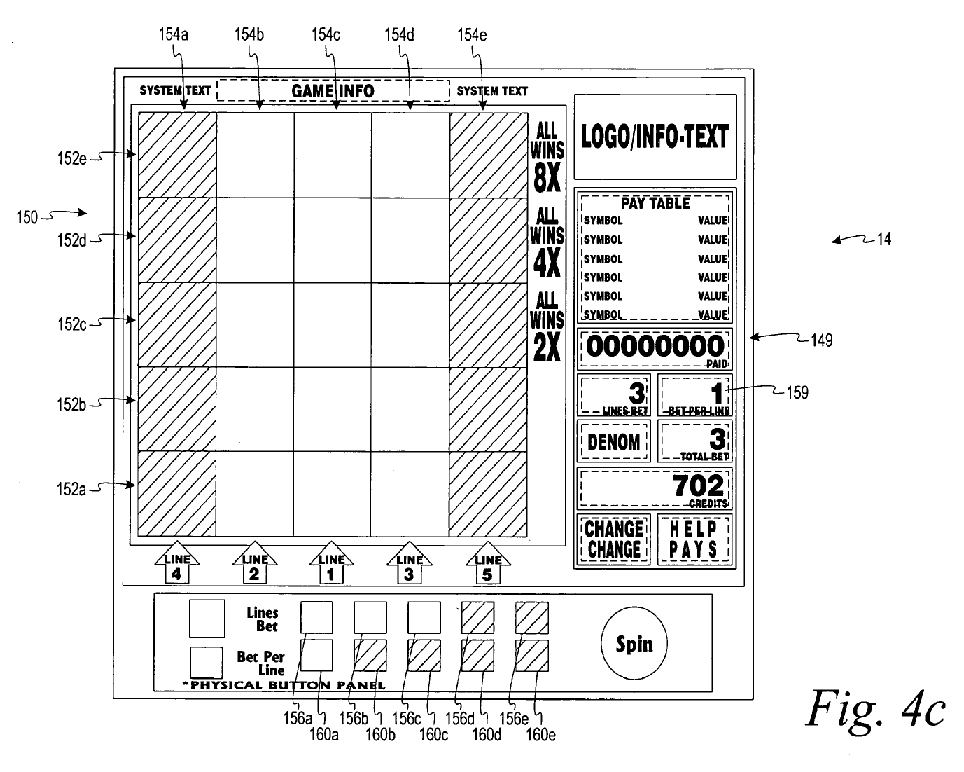

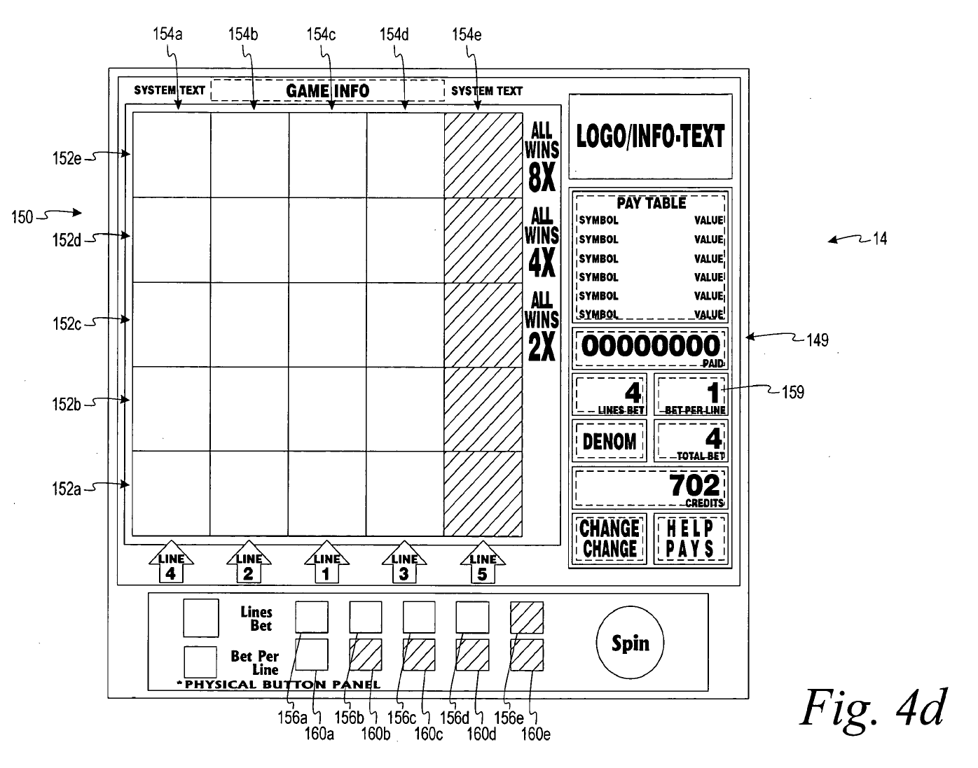

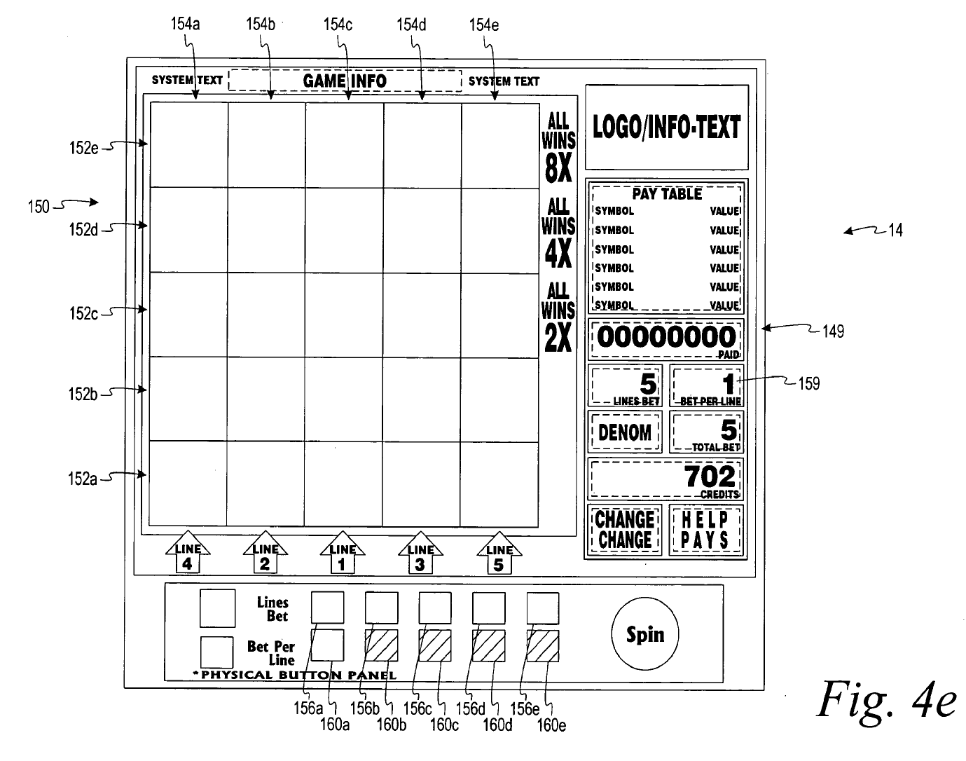

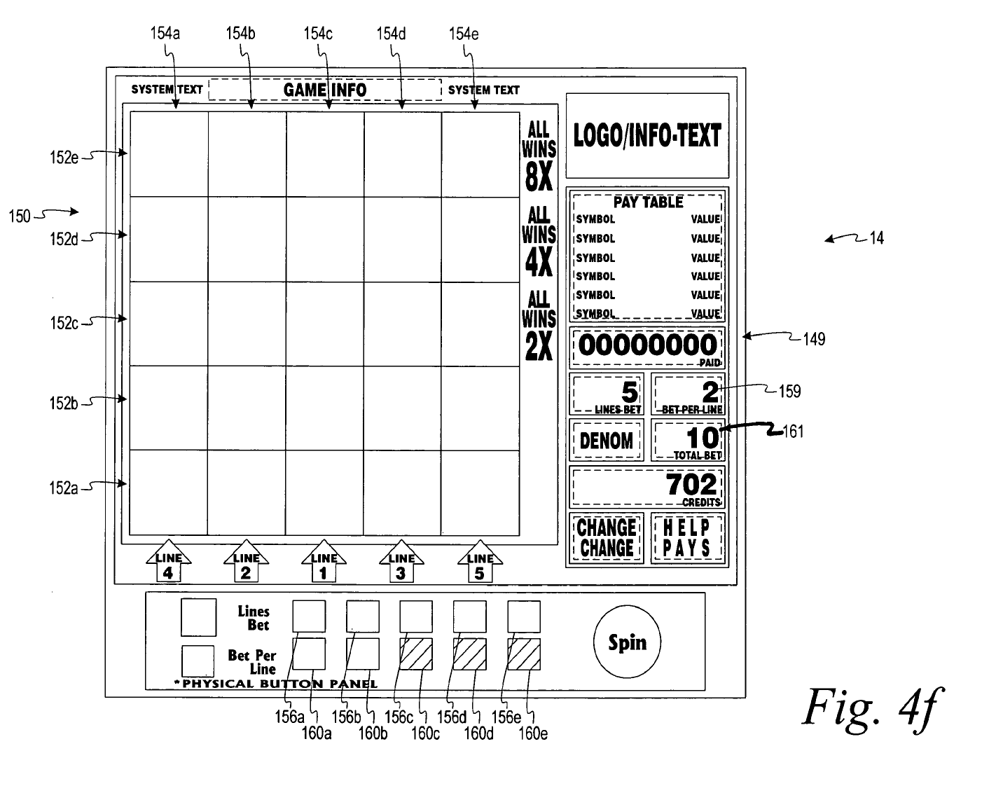

Turning now to FIGS. 4a-f, one way of placing wagers in, for example, the game of FIGS. 3a-g is shown. The wagering scheme of FIGS. 4a-f may also be used with other types of wagering games. FIGS. 4a-f show a display 14 similar to that of FIGS. 3a-g is shown. Because the focus of FIGS. 4a-f is to illustrate one possible wagering scheme, a representative view of the display 14 is shown without any symbols, themes, or the like thereon. The display 14 includes an outcome indicator 149 similar to the outcome indicator 75 of FIGS. 3a-g. Although the display 14 includes an array 150 having five rows 152a-e and five columns 154a-e, the wagering scheme of FIGS. 4a-f may also be applied to arrays having a different number of rows and/or columns. The display 14 includes five LINES BET buttons 156a-e corresponding with the five columns 154a-e.

As shown in FIG. 4a, when a player presses the first LINES BET button 156a, a single column (i.e., center column 154c) is activated, or “unlocked,” thereby allowing winning symbols to be generated in the activated column. Although in FIG. 4a, the activated column is the center column 154c, the activated column may be any one of the columns 154a-e. In one example, the player may select which of the five columns 154a-e he or she would like to activate using any suitable selection means. The activated center column 154c may be distinguished from the non-activated columns 154a,b,d,e in any suitable way, including those discussed above with respect to FIGS. 3a-g.

The player may press the second LINES BET button 156b to activate two columns, as shown in FIG. 4b. In the illustrated example, the two activated columns include the center column 154c and second column 154b. Pressing the second LINES BET button 156b may automatically activate two columns. Alternatively, the player may be required to press the first LINES BET button 156a to activate one column (e.g., the center column 154c) and the second LINES BET button 156b to activate another column (e.g., the second column 154b).

Similarly, as shown in FIG. 4c, pressing the third LINES BET button 156c activates three columns 154b-d. Although any three columns may be activated, FIG. 4c shows the second, center, and fourth columns 154b-d being activated. FIG. 4d shows the display 14 after the fourth LINES BET button 156d has been pressed. Accordingly, four columns 154a-d have been activated. Finally, FIG. 4e shows the display 14 after all five columns 154a-e have been activated by pressing the fifth LINES BET button 156e.

In FIGS. 4a-e, a wager amount of one credit per column is shown on the BET PER LINE indicator 159. However, in addition to selecting which and/or how many columns 154a-e to activate, the player may also select how many credits to bet per column 154a-e by pressing a BET PER LINE button 160a-e. The wager amount of one credit per line/column corresponds with the first BET PER LINE button 160a. As shown in FIG. 4g, pressing the second BET PER LINE button 160b, corresponds with a wager amount of two (2) credits per column, as shown in the BET PER LINE indicator 159. Because in this example, the player has activated five columns 154a-e, the player's total wager amount is ten credits (two credits wagered per each of the five columns 154a-e), as shown in a TOTAL BET indicator 161. Similarly, selecting the third BET PER LINE button 160c corresponds with a wager amount of three credits per column 154a-e, the fourth BET PER LINE button 160d corresponds with a wager amount of four credits per column 154a-e, and the fifth BET PER LINE button 160e corresponds with a wager amount of five credits per column 154a-e.

The wagering scheme of FIGS. 4a-f may be modified for embodiments in which the sequences of symbols are evaluated in different ways and/or directions. For example, the sequences may be evaluated top to bottom, left to right, right to left, or the like.

### Wagering Scheme 2

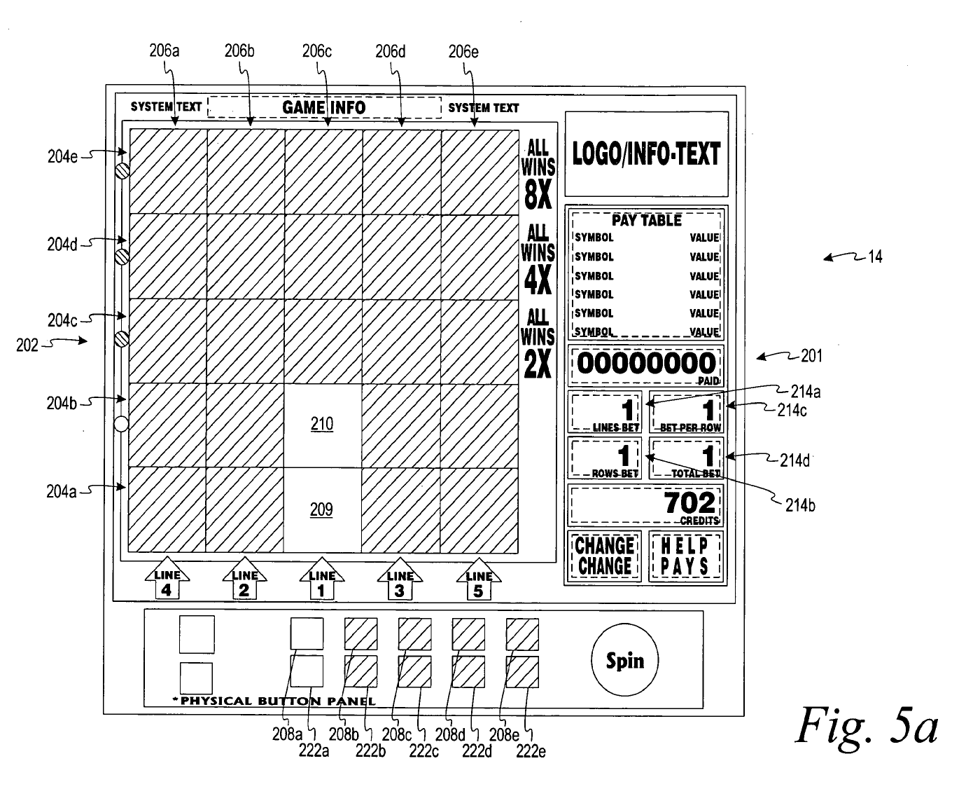

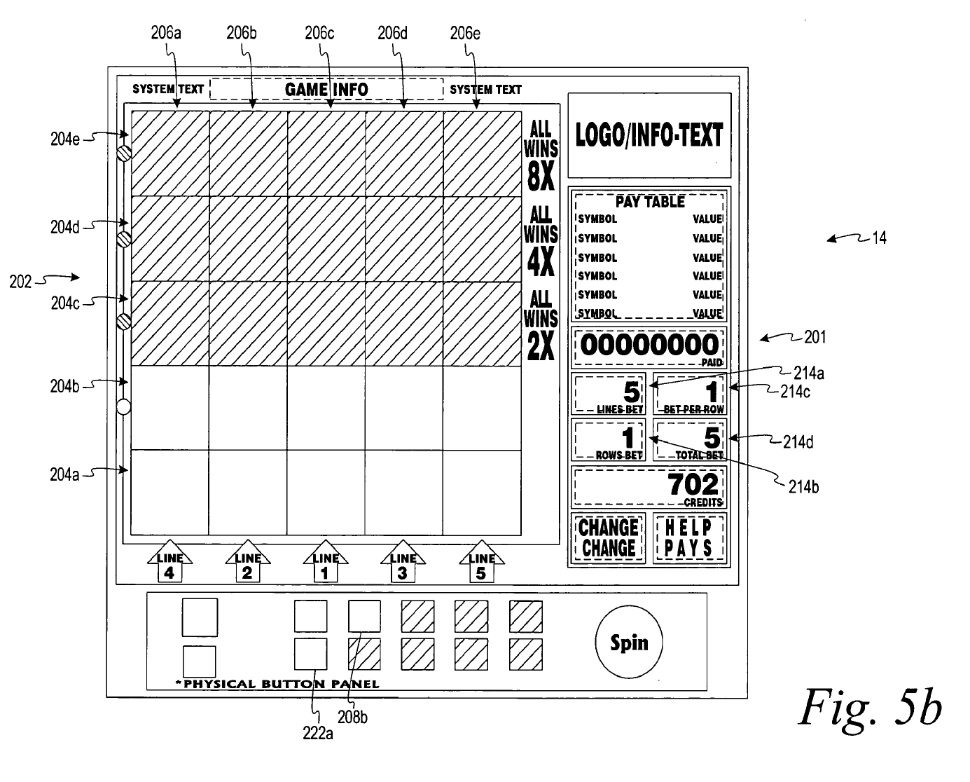

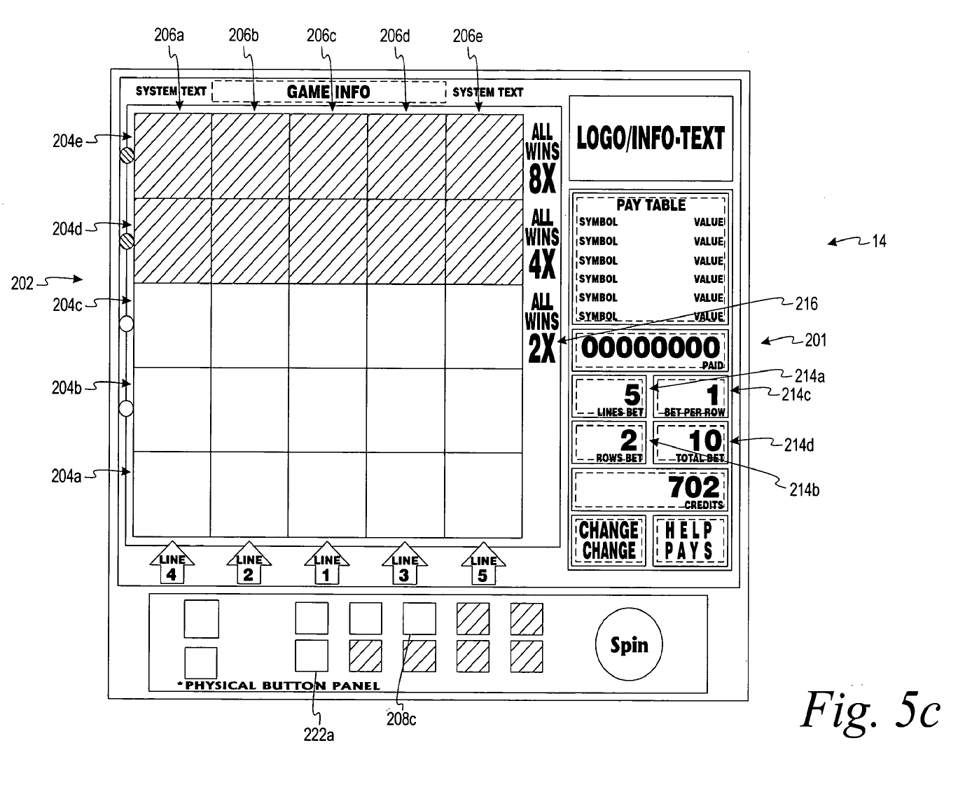

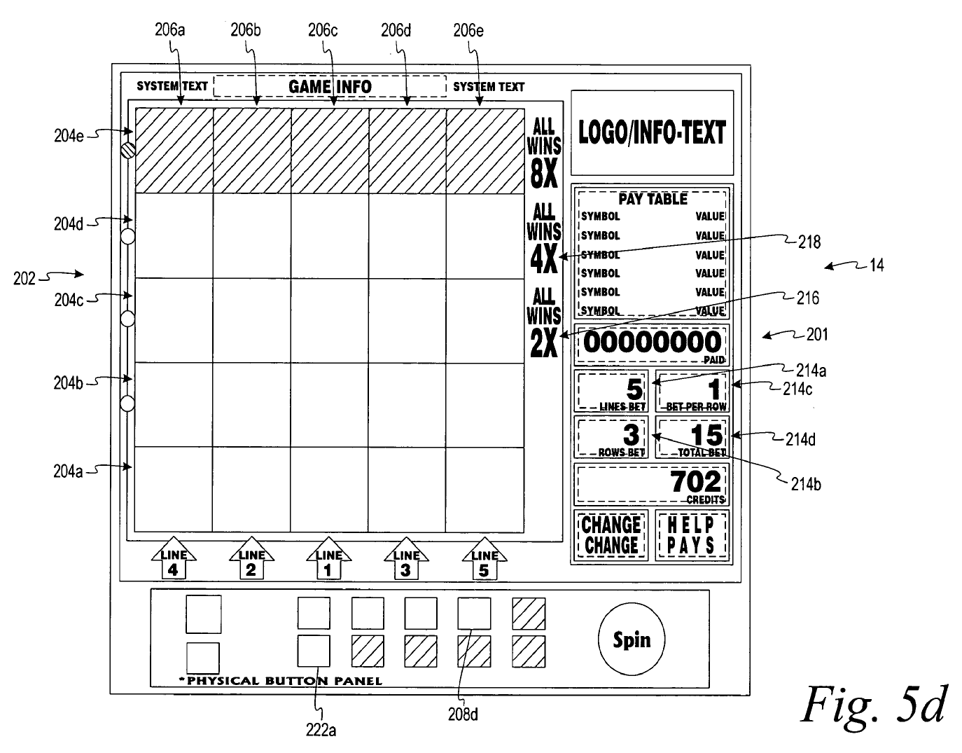

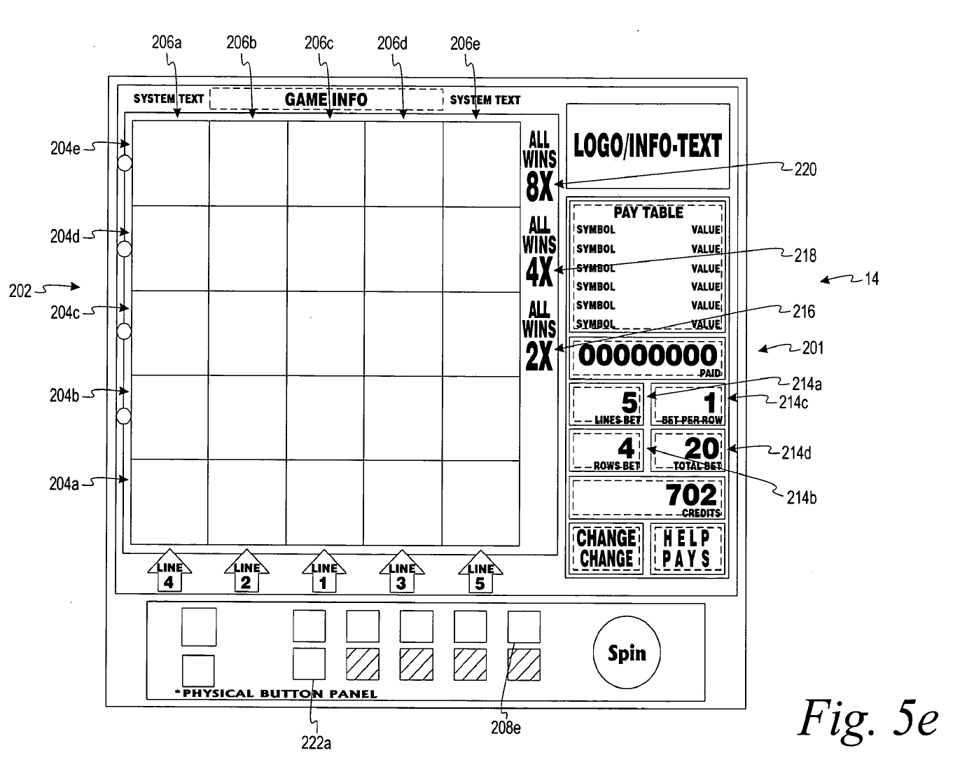

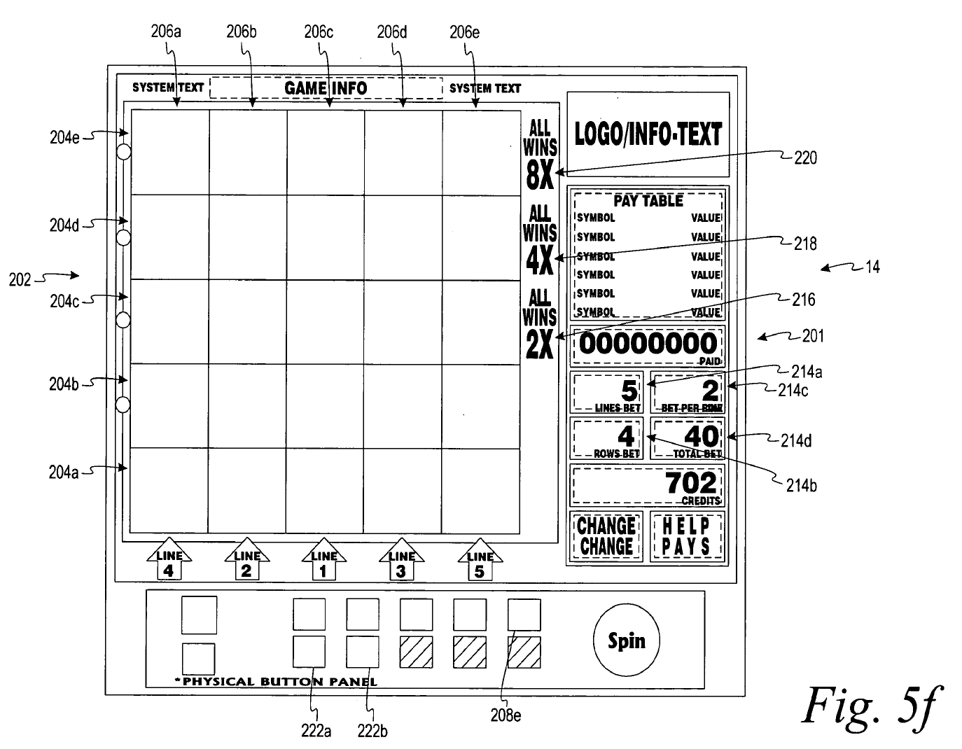

Another possible wagering scheme that may be used to place wagers in the wagering game of FIGS. 3a-g is shown in FIGS. 5a-e. The wagering scheme of FIGS. 5a-e may also be used with other types of wagering games.

Referring, for example, to FIG. 5a, a display 14 similar to that of FIGS. 4a-f is shown. The display includes an outcome indicator 201 similar to the outcome indicators 75, 149 shown in FIGS. 3a-g and 4a-f and described above. Although the display 14 of FIGS. 5a-e includes an array 202 having five rows 204a-e and five columns 206a-e, the wagering scheme of FIGS. 4a-f may also be applied to arrays having a different number of rows and/or columns. The display 14 further includes five buttons 208a-e for allowing a player to select which and/or how many cells of the array 202 to activate.

As shown in FIG. 5a, pressing the first button 208a activates two cells 209, 210 positioned in the first and second rows 204a,b of the center column 206c. Accordingly, the outcome indicator 201 indicates that the player had placed a wager on one (1) line or column 206c (LINES BET indicator 214a). The outcome indicator further indicates that the player has placed a wager on one (1) row 204b (ROWS BET indicator 214b). In the illustrated example, the first row 204a is “free” and is, thus, not included in the amount displayed in the ROWS BET indicator 214b. A BET PER ROW indicator 204c indicates that a wager of one (1) credit per row 204b was wagered. However, any number of credits per row may be wagered. Accordingly, a TOTAL BET indicator 214d of the outcome indicator 201 shows that a total wager of one (1) credit has been made.

Although the activated cells 209, 210 of FIG. 5a are located in the center column 206c, any cells positioned in the first and second rows 204a,b may be activated. In one example, the player may select which cells and/or columns 206a-e he or she would like to activate using any suitable selection means. The activated cells 209, 210 may be distinguished from non-activated cells in any suitable way, including those discussed above.

As shown in FIG. 5b, pressing a second button 208b activates all of the cells of the first row 204a and the second row 204b. Thus, the LINES BET indicator 214a indicates that the player had placed a wager on five (5) lines or columns 206a-e. The ROWS BET indicator 214b further indicates that the player has placed a wager on one (1) row 204b. The BET PER ROW indicator 204c indicates that a wager of one (1) credit per row 204b was wagered. Accordingly, the TOTAL BET indicator 214d shows that a total wager of five (5) credits has been made.

In FIG. 5c, pressing a third button 208c activates all of the cells of the first row 204a, the second row 204b, and the third row 204b. Thus, the LINES BET indicator 214a indicates that the player had placed a wager on five (5) lines or columns 206a-e. The ROWS BET indicator 214b further indicates that the player has placed a wager on two (2) rows 204b,c. The BET PER ROW indicator 204c indicates that a wager of one (1) credit per row 204b,c was wagered. Accordingly, the TOTAL BET indicator 214d shows that a total wager of ten (10) credits has been made. As described above, a payout for a winning symbol achieved in the third row 204c may be multiplied by a multiplier of two (2) (or any other suitable multiplier). The multiplier in FIGS. 5a-f) is designated by the “ALL WINS 2×” text 216.

As shown in FIG. 5d, pressing a fourth button 208d activates four rows 204a-d. Thus, the LINES BET indicator 214a indicates that the player had placed a wager on five (5) lines or columns 206a-e. The ROWS BET indicator 214b further indicates that the player has placed a wager on three (3) rows 204b-d. The BET PER ROW indicator 204c indicates that a wager of one (1) credit per row 204b-d was wagered. Accordingly, the TOTAL BET indicator 214d shows that a total wager of fifteen (15) credits has been made. A payout for a winning symbol achieved in the fourth row 204d is multiplied by a multiplier of four (4). The multiplier is designated by “ALL WINS 4×” text 218.

Similarly in FIG. 5e, pushing a fifth button 208e activates all five rows 204a-e. Thus, the LINES BET indicator 214a indicates that the player had placed a wager on five (5) lines or columns 206a-e. The ROWS BET indicator 214b further indicates that the player has placed a wager on four (4) rows 204b-e. The BET PER ROW indicator 204c indicates that a wager of one (1) credit per row 204b,c was wagered. Accordingly, the TOTAL BET indicator 214d shows that a total wager of twenty (20) credits has been made. A payout for a winning symbol achieved in the fifth row 204e is multiplied by a multiplier of eight (8). The multiplier is designated by “ALL WINS 8×” text 220.

Furthermore, the player may increase his or her wager by, for example, pressing an additional button 222a-e. Other suitable means may also be used. In FIGS. 5a-e, a first button 222a is highlighted, indicating that the first button 222a has been pressed. The first button 222a corresponds to a wager amount of one (1) credit per row 204a-e, as shown in a BET PER ROW indicator 214c. In FIG. 5f, pressing a second button 222b corresponds with a wager of two (2) credits per row 204a-e, as shown in the BET PER ROW indicator 214c. Similarly, pressing a third button 222c corresponds with a wager of three (3) credits per row 204a-e (not shown), pressing a fourth button 222d corresponds with a wager of four (4) credits per row 204a-e (not shown), and pressing a fifth button 222e corresponds with a wager of five (5) credits per row 204a-e (not shown).

Although in the illustrated examples, a button (e.g., 208a-e, 222a-e of FIGS. 5a-f) is pressed to select the activated lines and/or rows, any suitable method may be used. A different number of buttons 208a-e, 222a-e may also be used.

The wagering scheme of FIGS. 5a-f may be modified for embodiments in which the sequences of symbols are evaluated in different ways and/or directions. For example, the sequences may be evaluated top to bottom, left to right, right to left, or the like.

### Winning Links Wagering Game

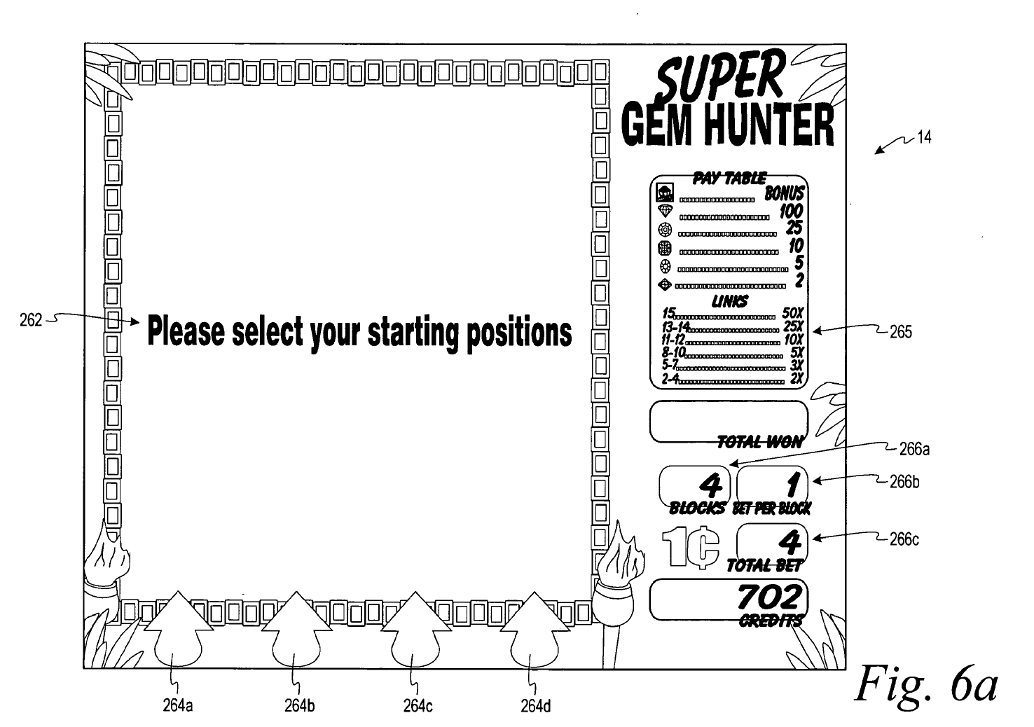

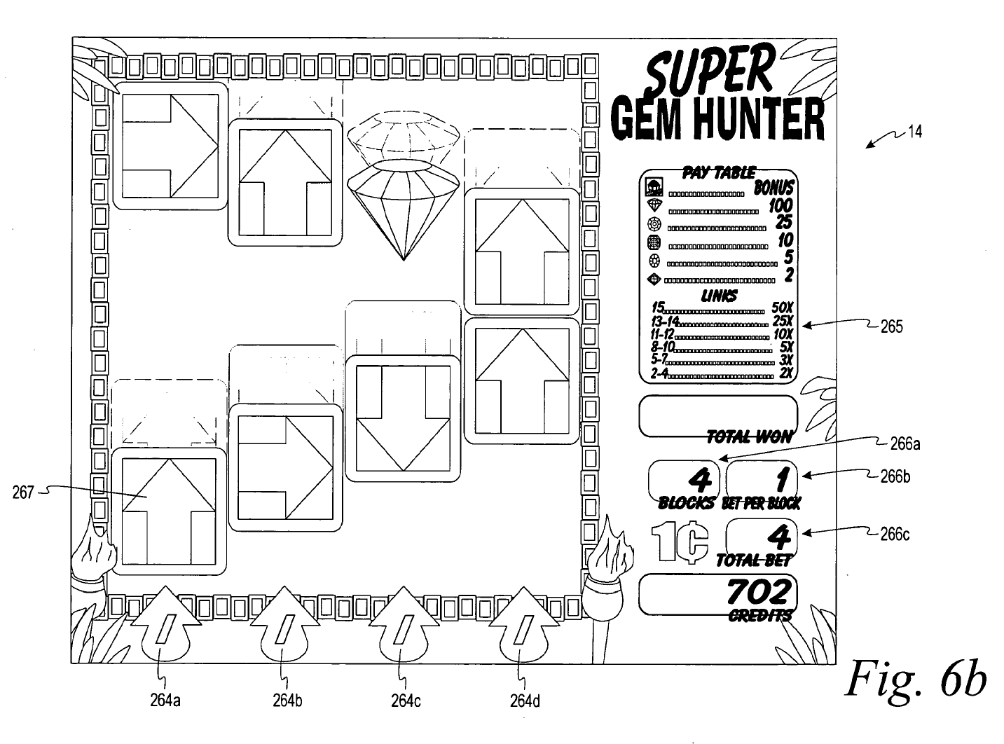

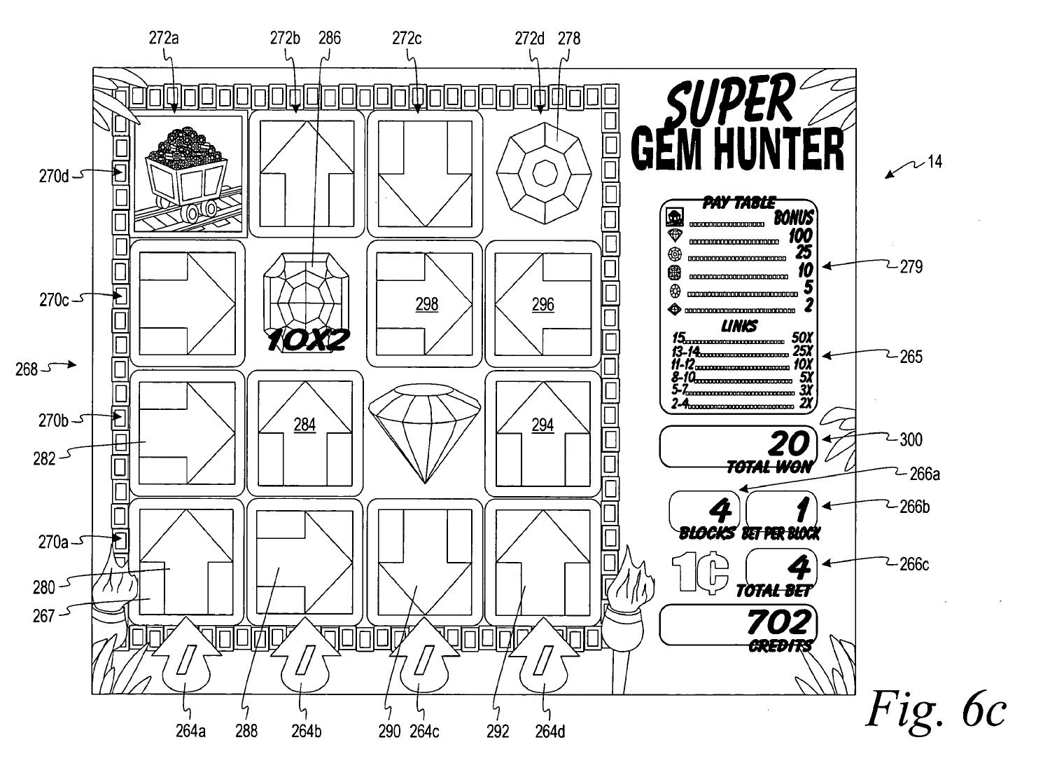

Turning now to FIG. 6a, the primary display 14 is shown according to another embodiment. The display 14 of FIG. 6a is generally displayed prior to beginning gameplay and includes text 262 prompting a player to select one or more starting positions 264a-d positioned near the bottom of the primary display 14. Although the illustrated embodiment includes four possible starting positions, any suitable amount of starting positions may be used. The starting positions 264a-d may also be located in other positions on the display 14, have other shapes, combinations thereof, or the like.

One or more starting positions 264a-d may be selected and activated by a player. The amount of starting positions 264a-d selected by the player may correspond with a wager amount as described above with respect to FIGS. 3a-g. For example, activating one starting position may require one credit, activating two starting positions may require two credits, etc. In other embodiments, other wager amounts may be made.

As shown in FIG. 6a, an outcome indicator 265 includes a BLOCKS indicator 266a that indicates that all four (4) blocks, or starting positions 264a-d, have been selected by the player. The outcome indicator 265 further includes a BET PER BLOCK indicator 266b that indicates that one (1) credit was wagered per block or starting position 264a-d. Thus, a TOTAL BETS indicator 266c indicates that a total of four (4) credits (one credit per each of the four starting positions 264a-e) have been wagered.

Once the player has placed the wager and selected and/or activated one or more starting positions 264a-d, the player may press a button (e.g., button 26 of FIG. 1a) or otherwise cause a plurality of symbols 267 to be revealed on the display 14, as shown in FIG. 6b. In the embodiment of FIG. 6b, each of the symbols 267 drops into place from the top of display 14. However, the symbols 267 may be revealed on the display 14 in other suitable ways. Moreover, the symbols 267 may appear on the display 14 one or more at a time or simultaneously. In one example, a gaming machine includes reels that spin and stop, either one at a time or simultaneously, thereby revealing the symbols 267.

Referring to FIG. 6c, once all of the symbols 267 have been revealed (e.g., dropped into position), an array 268 comprising four rows 270a-d and four columns 272a-d is formed. Each starting position 264a-d corresponds with a respective column 272a-d. Each row 270a-d and each column 272a-d includes four symbols 267. Other amounts of rows and/or columns may also be used. Furthermore, the rows 270a-d and columns 272a-d may also include other amounts of symbols 267.

Various types of symbols 267 are shown in the embodiment of FIGS. 6a-c. For example, the symbols 267 include directional symbols, or arrows 276 pointing in various directions. Various types of gem symbols (e.g., gem symbol 278) are also included in the illustrated embodiment. Other types of symbols 267 may also be used. According to one embodiment, a sequence of arrows is formed based on the direction in which the arrows 276 are pointing. If the chain is linked to a winning symbol, the player is awarded the credit value associated with that winning symbol. The credit value may further be multiplied by the number of links in the resulting chain.

Referring back to FIG. 6c, beginning at the first starting position 264a, the sequence begins with an up arrow 280 positioned in the first row 270a and the first column 272a. The sequence then continues in the direction of the up arrow 280 to an arrow pointing in the right direction (“right arrow”) 282 positioned in the second row 270b and the first column 272a. The sequence then continues to an up arrow 284 positioned to the right of the right arrow 282 in the second row 270b and the second column 272b. The sequence then continues up to a first gem symbol 286 positioned in the third row 270c and the second column 272b.

Because the sequence is linked to a winning gem symbol, the player is awarded a payout associated with the winning gem symbol according to a pay table 279, as shown on the outcome indicator 265. Referring to FIG. 6c, for example, according to the pay table 279, the first gem symbol 286 is a winning symbol corresponding with an award of ten (10) credits. The various winning symbols may also indicate prizes including monetary and non-monetary prizes. The non-monetary prizes may include free spins, multipliers, entry into a bonus game, entry into a progressive game, or the like.

The payouts associated with the respective winning symbols may be increased based on the number of links in the sequence ending with the winning symbol. The sequence beginning with the first starting position 264a includes four links (the up arrow 280, the right arrow 282, the up arrow 284, and the first gem symbol 286). Thus, according to the pay table 279, the player is awarded ten credits multiplied by two, or twenty credits, associated with the first starting position 264b. If only the first starting position 264a had been activated, the wagering game may end after the sequence corresponding with the first starting position 264a is determined.

Beginning now at the second starting position 264b, a second sequence begins with a right arrow 288 positioned in the first row 270a and the second column 272b. The sequence then continues in the direction of the right arrow 288 to an arrow pointing down (“down arrow”) 290 positioned in the first row 270a and the third column 272c. Because the sequence may not continue in the direction of the down arrow 290, the second sequence corresponding with the second starting position 264b ends and does not provide the player with an award or payout.

Beginning now with the third starting position 264c, a third sequence begins with the down arrow 290. As described with respect to the second starting position 264b, the third sequence may not continue in the direction of the down arrow 290 and, thus, ends and does not provide the player with an award or payout.

Finally, beginning with the fourth starting position 264d, a fourth sequence begins with an up arrow 292 positioned in the first row 270a and the fourth column 272d. The fourth sequence then proceeds in the direction of the up arrow 292 to an up arrow 294 positioned in the second row 270b and the fourth column 272d. The fourth sequence then continues in the direction of the up arrow 294 to an arrow pointing to the left (“left arrow”) 296. Because the fourth sequence is “blocked” by a right arrow 98 located to the left of the left arrow 296, the fourth sequence corresponding with the fourth starting position 264d ends and does not provide the player with an award or payout.

The sequences of symbols of the embodiments of the present invention may be displayed, for example, in different colors. Distinguishing the different sequences makes the different sequences readily identifiable to the player.

Although in the example of FIGS. 6a-c, the sequences of symbols are evaluated from the bottom of the display 14 to the top of the display 14, in other embodiments, the sequences may be evaluated top to bottom, left to right, right to left, or the like.

Each of these embodiments and obvious variations thereof is contemplated as falling within the spirit and scope of the claimed invention, which is set forth in the following claims.

1. A gaming system comprising:
a wager input device for receiving a wager; and
at least one display for displaying an array of symbols indicating a randomly selected outcome, the array of symbols including a plurality of rows and a plurality of columns, the symbols including directional indicators, the randomly selected outcome being indicated by at least one sequence of symbols formed based on directions associated with the directional indicators,
wherein, in response to the sequence of symbols including a predetermined symbol, an award associated with the predetermined symbol is awarded.

2. The gaming system of claim 1, wherein the array includes more than one starting position, each starting position being associated with a wager.

3. The gaming system of claim 1, wherein the directional indicators include upward arrows, the sequence of symbols being formed in a single column.

4. The gaming system of claim 1, wherein the symbols of the sequence of symbols are positioned in more than one row, column, or combination thereof.

5. The gaming system of claim 1, wherein the symbols further include one or more expanding symbols, the expanding symbol splitting the sequence of symbols into a plurality of branches.

6. The gaming system of claim 1, wherein each of the plurality of columns or each of the plurality of rows is consecutively revealed.

7. The gaming machine of claim 1, wherein the award is increased depending on the amount of symbols in the sequence of symbols, the position of the symbols in the array, or both.

8. A method of conducting a wagering game on a gaming system, the method comprising:
displaying a plurality of symbols in an array indicating a randomly selected outcome of the wagering game, the array including a plurality of rows and a plurality of columns, the plurality of symbols including directional indicators;
forming a sequence of symbols based on a direction associated with the directional indicators; and
in response to the sequence of symbols including a winning symbol, awarding an award associated with the winning symbol.

9. The method of claim 8, wherein the array includes more than one starting position, the method further comprising receiving a wager associated with one or more of the starting positions.

10. The method of claim 8, wherein the directional indicators include upward arrows, the sequence of symbols being formed in a single column.

11. The method of claim 8, wherein the symbols further include at least one expanding symbol, the expanding symbol splitting the sequence into a plurality of branches.

12. The method of claim 8, wherein each of the plurality of columns or each of the plurality of rows is consecutively revealed.

13. The method of claim 8, further comprising increasing the award based on the amount of symbols in the sequence of symbols.

14. A computer readable storage medium encoded with instructions for directing a gaming system to perform the method of claim 8.

15. A method of conducting a wagering game on a gaming system, the method comprising:
displaying an array including a plurality of symbol locations;
activating at least one starting position, the starting position being positioned adjacent to one of the symbol locations;
displaying a plurality of symbols in the array indicating a randomly selected outcome of the wagering game, the plurality of symbols including directional indicators
forming a sequence including a plurality of symbols, wherein a first symbol is adjacent to the activated starting position, a second symbol being adjacent to the first symbol in a direction associated with a first directional indicator of the first symbol, a third symbol being adjacent to the second symbol in a direction associated with a second direction indicator of the second symbol;
in response to the first symbol, the second symbol, or the third symbol being a winning symbol, awarding an award associated with the winning symbol.

16. The method of claim 15, wherein the at least one starting position is activated by receiving a wager.

17. The method of claim 15, wherein the directional indicators include upward arrows, the sequence of symbols being formed in a single column.

18. The method of claim 15, wherein the symbols further include expanding symbols, the expanding symbols splitting the sequence into at least two branches.

19. The method of claim 15, wherein each of the plurality of columns or each of the plurality of rows is consecutively revealed.

20. The method of claim 15, further comprising increasing the award based on the amount of symbols in the sequence of symbols.

21. The method of claim 15, further comprising causing the sequence to terminate.

22. The method of claim 21, wherein the act of causing the sequence to terminate is triggered by the winning symbol or a predetermined termination symbol.

23. The method of claim 21, wherein the act of causing the sequence to terminate is triggered by a symbol location adjacent to the third symbol in a direction associated with a third directional indicator of the third symbol is outside of the array or occupied by the first, second, or third symbols.
